(19) United States
(12) Patent Application Publication
(10) Pub. No.: US 2004/0078605 A1
(43) Pub. Date: Apr. 22, 2004

(54) One to many matching security system

(76) Inventors: Friedrich Gruber, Kirchbichl (AT); Robert Schmoelzer, Grinzens (AT)

Correspondence Address: John Vodopia, US Philips Corporation, Intellectual Property Department, PO Box 3001, Briarcliff Manor, NY, 10510, US

(21) Appl. No.: 10/471,505

(22) PCT Filed: Mar. 14, 2002
(86) PCT No.: PCT/IB02/00774

(30) Foreign Application Priority Data
Mar. 16, 2001 (EP) 01890085.2

(51) Int. Cl. H04L 9/32

(52) U.S. Cl. 713/202

(57) ABSTRACT

A computer system (1) comprises user terminals (2, 3, 4, 5) which are connected via a computer network (NET) to a server (6) which stores confidential data (PD). The user terminals (2, 3, 4, 5) contain an access control device (18) which is provided for controlling the authorization of a user of the computer system (1) to access the confidential data (PD). The access control device (18) allows various sets of authorization information (GPWI, GFPI) to be allocated to user information (UI), as a result of which the locking of a user terminal (2, 3, 4, 5) can be cancelled by several authorized users.

The invention relates to an access control device for controlling an access authorization of a user to access confidential data stored in a computer system.

The invention further relates to a computer system for accessing the confidential data stored in the computer system.

The invention further relates to an access control method of controlling the access authorization of a user to access confidential data stored in a computer system.

The invention further relates to a computer program product which is in the form of access control software executed by the computer system.

Such a computer system and such an access control device are known from a commercial computer that executes the Windows NT® computer software from the Microsoft company. When the known computer is switched on and the Windows NT® computer software is started, then the user must enter his User-ID (user information) and his password (authorization information), so that Windows NT® can be fully started. Windows NT® contains, by way of example, the Windows NT-Explorer® computer software with which confidential data which is stored on a hard disk of the computer can be accessed.

If the user of the computer leaves the computer for a certain time, then by pressing the “Ctrl-Alt-Del” combination of keys he can lock the computer so that access authorization for users of the computer to data stored with the computer is withdrawn. At this point the message “This computer is in use and has been locked. Only domain\User-ID or an administrator can unlock this computer.” is shown on the computer screen. The part of the Windows NT® computer program that allows the locking of access to confidential data constitutes an access control device.

The known access control device has turned out to have the disadvantage that the authorization of access can only be cancelled by a user who knows the password for the User-ID of the user entered at the time the computer program was started. This is a disadvantage, for example in hospitals or banks, in that often various doctors or bank clerks work on the same computer at different times and must access confidential data.

For example, in a hospital it very often happens that a first doctor starts up a computer and starts the hospital software with his User-ID and his password to retrieve confidential patient data. In the course of his work the doctor may be called away to an emergency and lock the computer quickly again to ensure the necessary protection of the confidential patient data. If another doctor wishes to query confidential patient data with the locked computer, then he cannot do this—even though he has his own User-ID and his own password—because for removing the lock on the computer the first doctor's password is necessary.

To solve this disadvantageous situation, computers in hospitals more often than not have one User-ID and one password which are known to all doctors and nurses on a ward. This solution has the major disadvantage, however, that it is impossible to know which doctor and which nurse may have queried, edited or possibly deleted what patient data. This opens the door to possible data fraud without it being possible to find out who handled what data.

The object of this invention is to provide an access control device of the type mentioned in the first paragraph, a computer system of the type mentioned in the second paragraph, an access control method of the type mentioned in the third paragraph and a computer program product of the type mentioned in the fourth paragraph, in which the disadvantages stated above are avoided.

To achieve the above-mentioned object, such an access control device features attributes in accordance with the invention so that the access control system can be characterized in the ways set out in the following:

An access control device for controlling the access authorization of a user to access confidential data stored in a computer system, comprising receiving means for receiving user information and authorization information entered by the user via input means of the computer system, and comprising memory readout means for reading out user information and authorization information stored in access memory means of the computer system, in which each set of stored user information can be stored with various sets of assigned authorization information, and comprising comparing means for comparing the received user information with the user information stored in the access memory means and for comparing the received authorization information with the authorization information stored in the access memory means, and comprising access granting means for granting authorization of access to users if the comparing means have found a match between the received user information and user information stored in the access memory means and a match between the received authorization information and one of the sets of authorization stored information assigned to this matching set of user information.

To achieve the above-mentioned object, such a computer system features attributes in accordance with the invention so that the computer system can be characterized in the ways set out in the following:

A computer system for accessing confidential data stored in the computer system, comprising data storage means for storing the confidential data, comprising access storage means for storing user information and authorization information of users who are authorized to access the stored confidential data, in which each set of stored user information can be stored with various sets of assigned authorization information, and comprising input means for entering user information and authorization information and comprising memory read-out means for reading out the confidential data stored in the data memory means if authorization of access has been granted by an access control device as claimed in claim 1.

To achieve the above-mentioned object, such an access control method provides attributes in accordance with the invention so that the access control method can be characterized in the ways set out in the following:

An access control method of controlling the authorization of access of a user to confidential data stored in a computer system in which the following method steps are executed:

Reception of user information and authorization information entered by the user using the input means of the computer system.

Reading out of user information and authorization information stored in the access memory means of the computer system, in which each set of user information can be stored with various sets of authorization information assigned to it.

Comparison of the received user information with user information stored in the access memory means and comparison of the received authorization information with authorization information stored in the access memory means.

Granting of authorization of access to the user if a match is found in the comparison between the received user information and one of the sets of user information stored by the access memory means and a match between the received authorization information and one of the sets of stored authorization information assigned to this matching set of user information.

In order to achieve the above-mentioned object such a computer program product features attributes in accordance with the invention, so that the computer program product can be characterized in the ways set out in the following:

A computer program product which can be directly loaded into the internal memory of a digital computer and comprises software code sections in which the steps of the transcription method are executed as claimed in claim 8 with the computer when the product runs on the computer.

This ensures that the access control device according to the access control method allows various sets of authorization information for each set of user information. In this way, for example, all doctors on a ward can have the same User ID but each will be able to access confidential patient data on a locked computer with their own password.

The advantage of this is that the locking of a computer on the ward does not have to be cancelled by the same doctor who locked the computer. An additional advantage gained is that through the use of individual passwords it is possible to retrace which doctor has queried, edited or deleted what patient data.

The measures of claim 2 and claim 9 offer the advantage that the access control device of the computer system automatically withdraws the authorization to access confidential data and locks the computer if the computer is not used for the period of a timeout and the user has forgotten to lock the computer.

The measures of claim 3 and claim 10 offer the advantage that following the automatic locking of the computer system the access control device allows access to confidential data if one of a number of user passwords is entered, which password must be stored assigned to the last set of user information successfully entered.

The measures of claims 4, 7 and 11 offer the advantage that the use of fingerprints as authorization information is particularly convenient for the user.

The measures of claim 5 offer the advantage that an administrator of the computer system can, if necessary, check which authorized users have accessed which confidential data and may have altered these without being authorized.

The invention is described by way of an example of embodiment shown in the Figures, but without this representing a restriction to the invention.

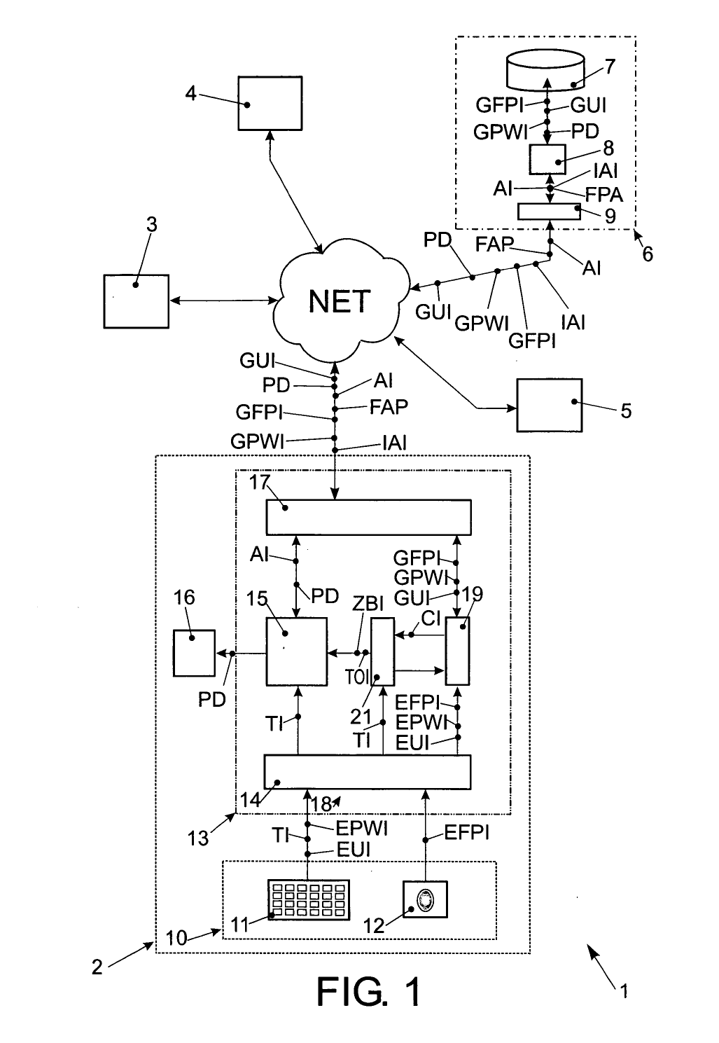

FIG. 1 shows a computer system with four user terminals, each of which having an access control device and with which, via a computer network, confidential patient data stored on a server can be retrieved.

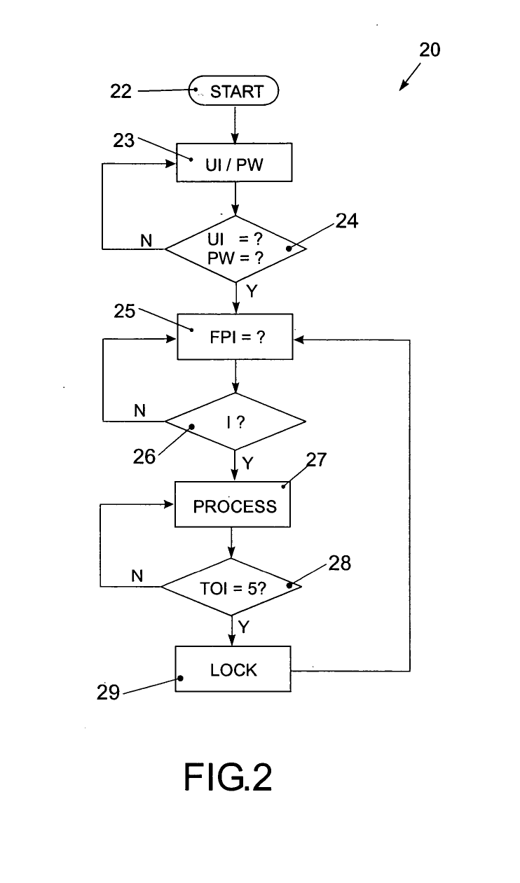

FIG. 2 shows a flow chart of an access control method, which is executed by the user terminal of the computer system as shown in FIG. 1.

FIG. 1 shows a computer system 1 which has four user terminals 2, 3, 4 and 5 which are connected to a server 6 via a computer network NET. The computer system 1 is installed in a hospital, where in each ward of the hospital a user terminal 2, 3, 4 or 5 is installed in order to allow doctors and nurses on the respective wards to enter, edit and query confidential patient data PD.

The patient data PD contains patient histories and other personal data on hospital patients and is stored centrally on the server 6. The server 6 is in the form of a commercial computer and contains a hard disk 7, computing means 8 and an interface 9. Query information AI, to query the patient data PD on a particular patient, can be transferred to the server 6 with each user terminal 2, 3, 4 and 5 via the computer network NET. For better clarity FIG. 1 only shows the information and data communicated between the user terminal 2 and the server 6.

The interface 9 contains a network card that forms the interface 9 for communication of data and information via the computer network NET. The query information AI received by the interface 9 can be transferred to the computing means 8. The computing means 8 are designed to read out the patient data PD characterized by the received query information AI and to transfer the patient data PD read out to the querying user terminal 2, 3, 4 or 5. Here the hard disk constitutes the data storage means for storage of confidential data.

The hard disk 7 further constitutes access information storage means for storage of user information and authorization information of authorized users of the computer system 1. The user information characterizes the respective authorized user and is stored by an administrator of the computer system 1 as stored User ID GUI on the hard disk 7 during a registration process. The authorization information is constituted by a stored set of password information GPWI and a stored set of fingerprint information GFPI, which information can be stored with assignment during the registration method of the stored User ID GUI of the respective user on the hard disk 7. A user of a user terminal 2, 3, 4 and 5 can only access confidential patient data PD if an access control device provided on the user terminal 2, 3, 4 and 5 has checked the user's authorization and has granted the authorization of access, further details of which will be given in the following.

The user terminals 2, 3, 4 and 5 have the same structure with the user terminal 2 being shown in detail in FIG. 1. The user terminal 2 contains input means 10 for entering an entered User ID EUI, an entered set of password information EPWI and further information, such as the patient data PD. For this purpose the input means 10 comprises a keyboard 11 and a fingerprint sensor 12.

The keyboard 11 is formed by a commercial keyboard and designed for transferring key information TI which contains the above-mentioned information. The fingerprint sensor 12 is designed for scanning a user's fingertips and for determining characteristic features of the fingerprint, in a generally known fashion. The characteristic features of the fingerprint determined by the fingerprint sensor 12 can be expressed by the fingerprint sensor 12 in input fingerprint information EFPI.

The user terminal 2 has a further terminal computer 13 which is in the form of a commercial computer. The terminal computer 13 contains receiving means 14, with which the key information TI and the input fingerprint information EFPI can be periodically queried by the input means 10. The user terminal 2 also has computing means 15 which are provided for creating query information AI according to the key information TI entered by the user and for processing received patient data PD. Processed patient data PD can be output to and displayed on a monitor 16 connected to the terminal computer 13 by means of the computing means 15.

The user terminal 2 also has an interface 17 which corresponds to the interface 9 of the server 6, and with which the user terminal 2 is provided for communication via the computer network NET. The parts of the user terminal 2 described above correspond to the state of the art, so that no further details of these are provided.

The user terminal 2 executes special access control software which forms a computer program product through which an access control device 18 is set up which works according to an access control method shown in FIG. 2. The access control device 18 is provided for controlling a user's authorization to access confidential patient data PD stored on the computer system 1. For this purpose the access control device 18 has receiving means for receiving the User ID EUI entered, password information EPWI entered and fingerprint information EFPI entered by the user with the input means 10 of the computer system 1, while the input means of the access control device 18 are constituted by the receiving means 14 of the terminal computer 13.

The access control device 18 also has memory read-out means for reading out the stored User ID GUI, password information GWPI and fingerprint information stored on the hard disk 7, while each stored User ID GUI can be stored with various sets of stored password information GPWI on the hard disk 7 and various sets of assigned stored fingerprint information GFPI. The memory readout means of the access control device 18 are constituted by the interface 17 of the terminal computer 13.

The access control device 18 also has comparing means 19 to compare the User ID EUI entered with the input means 10 with the User ID GUI stored on the hard disk 7. The comparing means 19 are also designed for comparing the password information EPWI entered with the input means 10 with the password information GPWI stored on the hard disk 7 and for comparing the fingerprint information EFPI entered by means of the fingerprint sensor 12 with the fingerprint information GFPI stored on the hard disk 7. Further details of this are provided via an example of application of the computer system 1 and a flow chart 20 shown in FIG. 2 of the access control method.

The access control device 18 also has access granting means 21 for granting authorization of access to the user of the user terminal 2, if the comparing means 19 find a match between the entered User-ID EUI and one of the User-ID's GUI stored with the hard disk 7 and a match between the password information EPWI entered and one of the stored sets of password information GPWI assigned to this matching user information EUI entered. Further details of this are likewise provided using the example of application and the flow chart which are to follow.

In accordance with the example of application it is assumed that a first doctor from the radiology ward of the hospital switches on the user terminal 2 to query patient data PD of the patient “Mr. Smith”. To do so the first doctor switches on the terminal computer 13, whereupon—in accordance with a block 22 of the flow chart 20—hospital software containing the access control software is started with the terminal computer 13.

In a block 23 the first doctor is prompted to enter his User ID EUI and his password information EPWI. The first doctor then enters the User ID EUI=“Radiology” and his password information EPWI=“R33T44” via the keyboard 11. This information is transferred as key information TI via the receiving means 14 to the comparing means 19. The interface 17 then transfers identification query information IAI to the server 6 to query the User ID GUI and the password information GPWI stored on the hard disk 7. This information is then read out from the hard disk 7 by the computing means 8 and transferred to the comparing means 19 via the interface 9, the computer network NET and the interface 17.

In a block 24 the comparing means 19 check if the User ID EUI entered by the first doctor is contained in the stored User IDs GUI. If such match can be found, then the matching User ID EUI=“Radiology” is transferred to the access granting means 21. Next the comparing means 19 check if in the stored password information GPWI assigned to the matching User ID the password information EPWI can be found. If such a match can be found then the comparing means 19 transfer the matching password information EPWI=“R33T44” to the access granting means 21.

In the block 24 the access granting means 21 now check if both the matching User ID EUI and the matching password information EPWI have been received by the comparing means 19. If the access granting means 21 find here that both sets of information have not been received, then access to the confidential patient data PD stored on the hard disk is denied and the process of the access control program continues with block 23. If the access granting means 21 finds, however, that both matching sets of information have been received, then the flow chart is continued with a block 25.

Assigning various stored sets of password information GPWI to the stored User ID GUI=“Radiology” has the advantage that, for example, all radiologists at the hospital can use the same user information, but that the computer system 1 can distinguish between the password information characterizing the individual radiologists. This is particularly important if the confidential data stored on the hard disk 7 has been handled improperly and the administrator of the computer system 1 wishes to find out who was responsible for this abuse of data.

At the block 25 the first doctor is invited by means of a prompt shown on the monitor 16, to place a finger determined during the registration method (for example the index finger) of his hand on the fingerprint sensor 12. The fingerprint sensor 12 then scans the characteristics of the fingerprint of the first doctor and transfers these as input fingerprint information EFPI via the receiving means 14 to the comparing means 19.

The interface 17 transfers at block 25 fingerprint query information FAP to the server 6, in order the query the fingerprint information GFPI stored on the user's hard disk 7 characterized by the matching User ID EUI and matching password information EPWI. The fingerprint information GFPI stored on the hard disk 7 for the matching User ID EUI and matching password information EPWI is then read out from the hard disk 7 by the computing means 8 and transferred to the comparing means 19 via the interface 9, the computer network NET and the interface 17.

At a block 26 the comparing means 19 check if the received fingerprint information EFPI sufficiently well matches the stored fingerprint information GFPI and transfer a set of matching information CI to the access granting means 21. At block 26 the access granting means 21 then check if the matching information represents a sufficiently good match between fingerprint information EFPI and GFPI.

If the access granting means 21 then find that there is an insufficient match, access to the confidential patient data PD stored on the hard disk 7 is initially denied and the processing of the access control software continues at block 25. If the access granting means 21 find, however, that there is a sufficient match, then a set of access authorization information ZBI is transferred to the computing means 15 and the flow chart is proceeded with at a block 27.

By querying the User-ID EUI and the password information EPWI and by the additional checking of the fingerprint of the first doctor, the greatest possible security is provided that the confidential patient data PD can actually only be queried by users who are authorized to do so. The advantages of storing various sets of fingerprint information GFPI for a stored User ID GUI are dealt with in more detail in the following.

At block 27 the first doctor has all the options for querying and handling the patient data PD offered by the hospital software. In accordance with the example of application the first doctor queries the patient data PD of the patient named “Smith”. To do so, he enters the matching information with the keyboard 11, whereupon the computing means 15—because of the presence of the access authorization information ZBI—create a matching set of query information AI and transfer this to the server 6. The server 6 thereupon reads the patient data for the patient named “Smith” from the hard disk and transfers this to the computing means 15, after which the first doctor receives the patient data PD that he requires displayed on the monitor 16.

In accordance with the example of application it is assumed that the first doctor is called away to an emergency and leaves the user terminal 2 in a hurry during the querying of the patient data PD. The access granting means 21 are now provided for activating a timeout mode and withdrawing the authorization of access previously granted, if for a predefined timeout period of, for example, five minutes no key information TI is received by the receiving means 14.

The advantage of this is that the user terminal 2 is automatically locked after the timeout period of five minutes. This prevents an unauthorized person querying confidential patient data PD with the user terminal 2 because the first doctor has forgotten to actively lock the user terminal 2.

At a block 28, the access granting means 21 check if key information TI has been received by the receiving means 14 during the last five minutes. Provided that this is the case the flow chart 20 stays at block 27. If, however, the access granting means 21 find that no further key information TI has been received during the last five minutes, then the access granting means 21—at a block 29—transfer a set of timeout information TOI to the computing means 15, as a result of which the timeout mode is activated on user terminal 2. The processing of the flow chart 20 then proceeds with block 25.

In accordance with the example of application, it is assumed that a second doctor from the radiology ward wishes to enter patient data on patient named “Jones” with the user terminal 2. Since the timeout mode is active on the user terminal 2, the second doctor must first have his authorization checked by the access control device 18. Following the prompt shown on the monitor 16, the second doctor places the finger determined during the registration method (for example his index finger) on the fingerprint sensor 12 after which the input fingerprint information EFPI is transferred to the comparing means 19 via the receiving means 14.

The interface 17 at block 25 once again transfers a set of fingerprint query information FAP to the server 6, in order to query all the stored fingerprint information GFPI entered by the first doctor and assigned to the User ID EUI=“Radiology” stored by the comparing means (19). With the timeout mode active on the user terminal 2 the comparing means at block 26 check if one of the sets of stored fingerprint information GFPI queried by the server 6 sufficiently matches the fingerprint information EFPI entered by the second doctor and transfers a matching set of matching information CI to the access granting means 21. The access granting means 21 grant or deny the second doctor's access to the confidential patient data PD according to the information content of the match information CI.

The advantage of this is that the comparing means 19 for comparing the fingerprint information EFPI comprise various sets of stored fingerprint information GFPI assigned to the matching User ID EUI. Thus the second doctor can use user terminal 2 to enter the patient data of the patient named “Jones” once the authorization of access has been granted by the access control means 21. This avoids the disadvantages of known computer systems in which a locked user terminal can only be unlocked by the user who activated the lock, which is a major disadvantage in a hospital.

Since the check by the comparing means 19 provides that only doctors whose authorization information is stored assigned to the User ID GUI=“Radiology” will be granted access to the patient data PD, advantageously a restriction of the users of user terminal 2 desired by the administrator of the computer system 1 is provided.

It may be observed that the access control device instead of being in each user terminal can also be provided on the server only. This configuration would have the advantage that the stored User IDs GUI, the stored sets of password information GWPI and the stored set of fingerprint information GFPI do not need to be transferred across the computer network NET for whenever there is a check by the access control device. In this way the data security of the computer system 1 can be further enhanced.

It may be observed that at block 23 instead of the user's password information EPWI the user's fingerprint information EFPI could be directly queried as a result of which blocks 25 and 26 could be dispensed with.

It may be observed that in the timeout mode the user's password information EPWI could be queried instead of the fingerprint information EFPI. In that case the comparing means would check if the password information EPWI entered corresponded with one of the stored sets of password information GPWI assigned to the User ID EUI stored in the comparing means.

It may be observed that the user terminal 2 can also be locked by the first doctor by actuating a certain combination of keys on the keyboard 11, as a result of which the timeout mode would also be activated on operating terminal 2.

It may be observed that the server or also the user terminal could have log file means, with which a set of log file information could be determined and stored. This log file information features the time of access, the user and the stored confidential data if a user has accessed confidential data stored on the computer system after he has been granted access.

It may be observed that the user could also use a smart card or similar known means of identification as authorization information.

1. An access control device (18) for controlling an access authorization of a user to access confidential data (PD) stored in a computer system (1), comprising receiving means (14) for receiving user information (EUI) and authorization information (EPWI, EFPI) entered by the user via input means (10) of the computer system (1), and comprising memory readout means (17) for reading out user information (GUI) and authorization information (GPWI, GFPI) stored in access storage means (7) of the computer system (1), in which each set of stored user information (GUI) can be stored with various sets of assigned authorization information (GPWI, GFPI), and comprising comparing means (19) for comparing the received user information (EUI) with the user information (GUI) stored in the access memory means (7) and for comparing the received authorization information (EPWI, EFPI) with the authorization information (GPWI, GFPI) stored in the access memory means (7), and comprising access granting means (21) for granting authorization of access to users if the comparing means (19) have found a match between the received user information (EUI) and user information (GUI) stored in the access memory means (7) and a match between the received authorization information (EPWI, EEPI) and one of the sets of stored authorization information (GWPI, GFPI) assigned to this matching set of user information (GUI).

2. An access control device (18) as claimed in claim 1 in which the access granting means (21) are provided for activating a timeout mode of the access control device (18) and in this case for withdrawing the authorization of access for the users featured by the received authorization information (EPWI, EEPI), if not at least one set of input information has been received by the receiving means (14) during a timeout period.

3. An access control device (18) as claimed in claim 2 in which the comparing means (19) are provided for comparing the received authorization information (EPWI, EFPI) with the authorization information (GPWI, GFPI) stored in the access memory means (7) after receipt of the authorization information (EPWI, EFPI) when the access control device (18) is in a timeout mode and assigned to the matching user information (EUI), and in which the access granting means (21) are provided for granting the authorization of access to the user if the comparing means (19) have found a match with the authorization information (EPWI, EFPI, GPWI, GFPI) compared by the comparing means (19) in the timeout mode.

4. An access control device (18) as claimed in claim 1 in which the receiving means (14) are provided for receiving fingerprint information (EFPI) from a fingerprint sensor (12) of the computer system (1) and the comparing means (19) are provided for processing the received fingerprint information (EFPI) as authorization information.

5. An access control device (18) as claimed in claim 1 in which log file means are provided for determining and storing log file information, which log file information designates the instant of access, the user-and the stored confidential data (PD) if a user has accessed confidential data (PD) stored in the computer system (1) after being granted authorization of access.

6. A computer system (1) for accessing confidential data (PD) stored in the computer system (1), comprising data storage means (7) for storing the confidential data (PD), comprising access memory means (7) for storing user information (GUI) and. authorization information (GPIW, GFPI) of users who are authorized to access the stored confidential data (PD), in which each set of stored user information (GUI) can be stored with various sets of assigned authorization information (GPWI, GFPI), and comprising input means (10) for entering user information (EUI) and authorization information (EPWI, EFPI) and comprising memory read-out means (17) for reading out the confidential data (PD) stored in the data memory means (7) if an authorization of access has been granted by an access control device (18) as claimed in claim 1.

7. A computer system (1) as claimed in claim 6 in which the input means (10) contain a keyboard (11) and a fingerprint sensor (12).

8. An access control method (20) of controlling the authorization of access of a user to confidential data (PD) stored in a computer system (1), in which the following method steps are executed:
Reception of user information (EUI) and authorization information (EWPI, EFPI) entered by the user using input means (10) of the computer system (1);
Reading out of user information (GUI) and authorization information (EWPI, EFPI) stored in the access memory means (7) of the computer system (1), in which each set of user information (GUI) can be stored with various sets of authorization information assigned to it;
Comparison of the received user information (EUI) with user information (GPWI, GFPI) stored in the access memory means (7) and comparison of the received authorization information (EWPI, GFPI) with authorization information (GPWI, GFPI) stored in the access memory means (7);
Granting of authorization of access to the user if a match is found in the comparison between the received user information (EUI) and one of the sets of user information (GUI) stored by the access memory means (7) and a match between the received authorization information (EPWI, EFPI) and one of the sets of stored authorization information (GUI) assigned to this matching set of user information GUI.

9. An access control method (20) as claimed in claim 8 in which the following additional method step is executed:
Activation of a timeout mode and in that case withdrawal of the authorization of access from the user who is featured by the received authorization information (EWPI, EFPI), if during a timeout period at least one set of input information has not been received.

10. An access control method as claimed in claim 9 in which the following additional method steps are executed:
Comparison of the received authorization information (EPWI, EFPI) with authorization information (GPWI, GFPI) assigned to the matching user information (EUI) and stored in the access memory means (7), if authorization information (EWPI, EFPI) has been received and the timeout mode is activated;
Granting the authorization of access to the user if the comparing means (19) have found a match between the authorization information (EPWI, EFPI, GPWI, GFPI) compared in the timeout mode.

11. An access control method (20) as claimed in claim 8 in which fingerprint information (EFPI) is evaluated as authorization information, which fingerprint information (EFPI) features the characteristics of a user's fingerprint.

12. A computer program product which can be loaded directly into the internal memory of a digital computer (2, 3, 4, 5) and which comprises software code sections, in which the steps of the access control method (20) are executed with the computer (2, 3, 4, 5) as claimed in claim 8 when the product runs on the computer (2, 3, 4, 5).

13. A computer program product as claimed in claim 12 in which it is stored on a medium that can be read by a computer.
